(19) United States
(12) Patent Application Publication
(10) Pub. No.: US 2013/0342211 A1
(43) Pub. Date: Dec. 26, 2013

(54) Impedance Spectroscopy Measurement Device And Methods For Analysis Of Live Reservoir Fluids And Assessment Of In-Situ Corrosion Of Multiple Alloys

(71) Applicant: SCHLUMBERGER TECHNOLOGY CORPORATION, Sugar Land, TX (US)

(72) Inventors: Indranil Roy, Sugar Land, TX (US); Manuel P. Marya, Sugar Land, TX (US); Kuo-Chiang Chen, Sugar Land, TX (US); Amit Mohan, Kakinada (IN); Richard Lewis, Frisco, TX (US); Craig Borman, Camrose (CA); Tatiana Reyes Hernandez, Houston, TX (US); Srinand S. Karuppoor, Sugar Land, TX (US); Rashmi B. Bhavsar, Houston, TX (US); Oliver C. Mullins, Ridgefield, CT (US)

(73) Assignee: SCHLUMBERGER TECHNOLOGY CORPORATION, Sugar Land, TX (US)

(21) Appl. No.: 13/796,960

(22) Filed: Mar. 12, 2013

Related U.S. Application Data
(60) Provisional application No. 61/664,240, filed on Jun. 26, 2012.

(51) Int. Cl. G01V 3/02

(52) U.S. Cl. CPC G01V 3/02
USPC 324/376

(57) ABSTRACT

A method for analyzing fluid withdrawn from a subsurface formation includes disposing the withdrawn fluid in a chamber and maintaining the fluid in the chamber substantially at a same temperature and pressure as exists in the subsurface formation. Electric current is passed through the fluid in the chamber using at least one electrode made from a selected metal, the electric current comprising direct current and alternating current of frequency sufficient to determine at least one of (i) resistance of the fluid sample in the chamber directly and (ii) from the direct current determine a polarization resistance of the at least one electrode.

### CROSS-REFERENCE TO RELATED APPLICATION

This application claims the benefit of a related U.S. Provisional Patent Application Ser. No. 61/664,240, filed Jun. 26, 2012, entitled “IMPEDANCE SPECTROSCOPY MEASUREMENT DEVICE AND METHODS FOR ANALYSIS OF LIVE RESERVOIR FLUIDS AND ASSESSMENT OF IN-SITU CORROSION OF MULTIPLE ALLOYS,” the disclosure of which is incorporated by reference herein in its entirely.

### BACKGROUND

This disclosure relates generally to the field of determining electrical properties of formation fluids at the temperatures and pressures at which they exist in subsurface formations. More specifically, the disclosure relates to methods and apparatus for measuring such electrical properties and effects such fluids may have on rates of corrosion of metallic components used to complete construction of wellbores drilled through formations containing such fluids.

In order to interpret formation electrical resistivity data acquired by various resistivity well logging instruments, e.g., wireline conveyed instruments such as array induction, triaxial induction, or logging while drilling (LWD) instruments such as the MicroScope LWD instrument, arcVISION LWD instrument, geoVISION imaging LWD instrument (the foregoing being trademarks of Schlumberger Technology Corporation of Sugar Land, Tex.), knowledge of the conductivity of fluids in the pore spaces of the subsurface formations, especially formation connate water, is important.

Information on R_{W}@BHT (formation water resistivity at formation temperature), RMF@MST (resistivity of drilling mud filtrate at surface pressure and temperature), salinity, acid gases dissolved in reservoir fluids, etc., are available in various forms. The ability to transform such information from one form to another is important for proper interpretation of well log data. In addition, interpretation programs known in the art may require the ability to cause the conductivity of formation water used in the interpretation to change as the apparent formation temperature changes. As an example only, an interpretation technique sold under the service mark ELAN, which is a service mark of Schlumberger Technology Corporation, Sugar Land, Tex., uses such feature. It may also be desirable that the temperature to conductivity transform have smooth and continuous first and second derivatives. This can be implemented in computer-readable encoded instructions written using, for instance, an algorithm that computes the water conductivity as a function of sodium chloride (NaCl) concentration and temperature (pressure effects are not considered). The current algorithm is believed to be accurate within 2% over a temperature range of 32 degrees to 400 degrees Fahrenheit and a salinity range of 0 to 260 ppk (parts per thousand concentration).

Experimental results corroborated by thermodynamic modeling of formations fluids at actual reservoir pressure and temperature conditions, contrary to conventional expectations, discovered a tendency of dense gases with high relative humidity at high pressure and high temperature (HPHT) reservoir conditions to solvate halides, screen ions and exhibit ionic activity. For the purposes of this disclosure, high pressure and high temperature conditions is understood to mean reservoir conditions at a temperature of about 300 degrees F. in temperature and a pressure of about 10,000 pounds per square inch (psi) or higher.

Modeling resistivity of brine solutions at HPHT conditions, it has been observed that the current interpretation services may not accurately predict the resistivity (or conductivity) of brine solutions at higher temperatures and pressures. As discussed before, only temperature effects on resistivity of formation brines are determined using some interpretation services (with pressure effects not being considered), such as certain versions of Schlumberger Technology Corporation's ELAN service. Also, the effect of certain ions in solution, including dissolved acid gases and buffers, on the resistivity of a live reservoir fluid has not been previously considered. From laboratory and modeling findings, it has been determined that wet, supercritical fluids having inorganic ions in their dielectric continuum can potentially be conductive. The foregoing findings have not previously been accounted for in interpretation techniques known in the art. Accordingly, providing the ability to accurately determine formation fluid resistivity at existing reservoir conditions as well as to be able to determine likely effects of formation fluids on corrosion of materials used to complete construction of wellbores through such formations would be useful in the field of formation evaluation.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A method according to one aspect for analyzing fluid withdrawn from a subsurface formation includes disposing the withdrawn fluid in a chamber and maintaining the fluid in the chamber substantially at a same temperature and pressure as exists in the subsurface formation. Electric current is passed through the fluid in the chamber using at least one electrode made from a selected metal, the electric current having direct current and alternating current of frequency sufficient to determine at least one of (i) resistance of the fluid sample in the chamber directly and (ii) from the direct current determine a polarization resistance of the at least one electrode.

Other aspects and advantages will be apparent from the description and claims which follow.

### BRIEF DESCRIPTION OF THE DRAWINGS

Certain embodiments are described below with reference to the following figures:

FIG. 1 shows an example of a well site system that may be used to obtain formation fluids samples during the drilling of a wellbore, in accordance with aspects of the present disclosure.

FIG. 2 shows an example of obtaining formation fluid samples using a wireline or similarly conveyed fluid sampling instrument in accordance with an embodiment of the present disclosure.

FIG. 3 illustrates the principle of a Randle's Cell to show how some example implementations may be used to estimate corrosion effects on metallic components in a wellbore in accordance with aspects of the present disclosure.

FIG. 4 shows an example impedance spectroscopy system for determining fluid resistivity and electrode resistance in accordance with an embodiment of the present disclosure.

FIGS. 5 and 6 show examples of a test cell which may be implemented in a wellbore testing instrument or at the Earth's surface in accordance with embodiments of the present disclosure.

FIG. 7 shows another example of a test cell in accordance with an embodiment of the present disclosure.

### DETAILED DESCRIPTION

The present description is made with reference to the accompanying drawings, in which example embodiments are shown. However, many different embodiments may be used, and thus the description should not be construed as being limited to the embodiments set forth herein. Rather, these embodiments are provided so that this disclosure will be thorough and complete. Generally, like numbers refer to like elements throughout the present description.

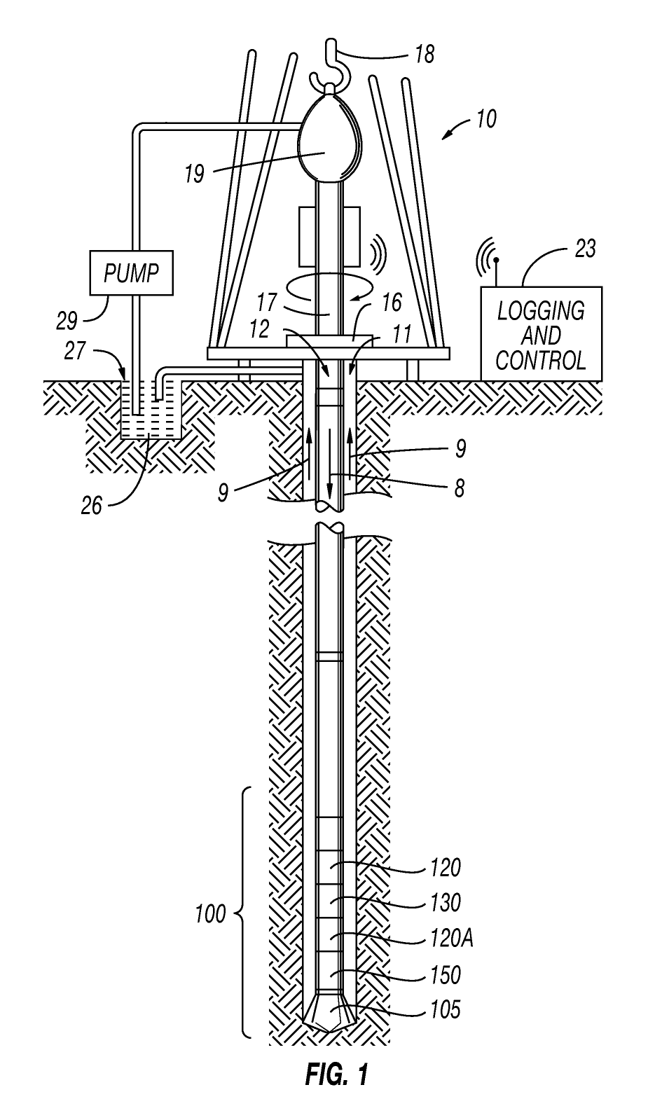

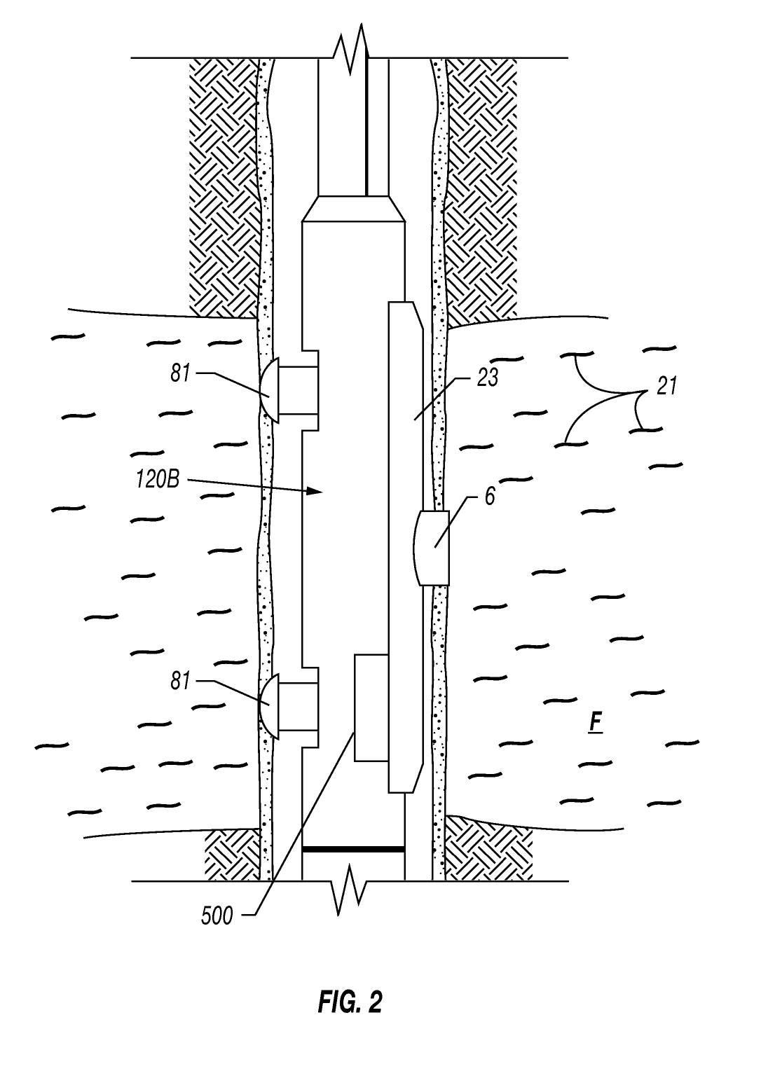

Various examples of methods and apparatus to be explained herein may be implemented in a wellbore fluid sample taking and analysis instrument. Such instruments may be conveyed through a wellbore during or after drilling thereof as part of a drill string assembly. Other examples of such instruments may be conveyed into a wellbore using armored electrical cable (wireline), coiled tubing, workover pipe, production tubing or any other conveyance method known in the art. Two examples will now be explained with reference to FIGS. 1 and 2.

FIG. 1 illustrates a well site system 10 in which the wellbore fluid sample taking instrument can be implemented. The well site can be onshore or offshore. In this example system, a borehole 11 is formed in subsurface formations by rotary drilling in a manner that is well known. Embodiments of the drilling system 10 can also use directional drilling, as will be described hereinafter.

A drill string 12 is suspended within the borehole 11 and has a bottom hole assembly 100 which includes a drill bit 105 at its lower end. The surface system includes platform and derrick assembly 10 positioned over the borehole 11, the assembly 10 including a rotary table 16, kelly 17, hook 18 and rotary swivel 19. The drill string 12 is rotated by the rotary table 16, energized by means not shown, which engages the kelly 17 at the upper end of the drill string. The drill string 12 is suspended from a hook 18, attached to a traveling block (also not shown), through the kelly 17 and a rotary swivel 19 which permits rotation of the drill string relative to the hook 18. As is well known, a top drive system could alternatively be used.

In the present example, the surface system may further include drilling fluid or mud 26 stored in a pit 27 formed at the well site. A pump 29 delivers the drilling fluid 26 to the interior of the drill string 12 via a port in the swivel 19, causing the drilling fluid to flow downwardly through the drill string 12 as indicated by the directional arrow 8. The drilling fluid exits the drill string 12 via ports in the drill bit 105, and then circulates upwardly through the annulus region between the outside of the drill string and the wall of the borehole, as indicated by the directional arrows 9. In this well known manner, the drilling fluid lubricates the drill bit 105 and carries formation cuttings up to the surface as it is returned to the pit 27 for recirculation.

A bottom hole assembly 100 of the illustrated embodiment includes a logging-while-drilling (LWD) module 120, a measuring-while-drilling (MWD) module 130, a rotary steerable directional drilling system and motor (not shown separately) 150, and the drill bit 105.

The LWD module 120 may be housed in a special type of drill collar, as is known in the art, and can contain one or a plurality of known types of logging tools. It will also be understood that more than one LWD and/or MWD module can be employed, e.g., as represented at 120A. (References, throughout, to a module at the position of 120 can thus also mean a module at the position of 120A as well.) The LWD module includes capabilities for measuring, processing, and storing information, as well as for communicating with surface deployed equipment, shown as a logging and control unit 23, which may include devices for recording and/or interpreting information communicated from the LWD and/or MWD module. In the present embodiment, the LWD module 120 (and/or 120A) includes a fluid sampling device.

The MWD module 130 may also be housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

FIG. 2 shows a simplified diagram of a sampling or sampling-while-drilling device 120B of a type described, for example, in commonly owned U.S. Pat. No. 7,594,541 (also published as U.S. Patent Application Publication No. 2008/0156486), which is incorporated herein by reference in its entirety. The sampling device 120B used as the LWD tool 120 or part of an LWD tool suite 120A. As shown, the sampling while drilling device 120B is provided with a probe 6 for establishing fluid communication with the formation F and drawing the fluid 21 into the tool, as indicated by the arrows. The probe 6 may be positioned in a stabilizer blade 23 of the LWD tool 120 and may be laterally extended therefrom to engage the borehole wall. The stabilizer blade 23 may include one or more blades that are in contact with the borehole wall. Fluid drawn into the sampling while drilling device 120B using the probe 6 may be measured to determine, for example, pretest and/or pressure parameters. Additionally, the sampling while drilling device 120B may be provided with additional fluid sample processing devices, such as one or more sample chambers 500, for collecting fluid samples for retrieval at the surface. Backup pistons 81 may also be provided to assist in applying force to push or otherwise urge the drilling tool and/or probe against the borehole wall. It should be clearly understood that the example system shown in FIG. 2 may also be conveyed by means other than a drill string, as explained above. For instance, the fluid sampling device 120B could be conveyed using wireline.

As stated above, for the purposes of this disclosure, high pressure and high temperature conditions (HPHT) is understood to mean reservoir conditions at a temperature of about 300 degrees F. in temperature and a pressure of about 10,000 pounds per square inch (psi) or higher. By way of example, conditions up to 600 degrees F. and 40,000 psi may be considered HPHT conditions, though these example values should not be construed as necessarily implying upper limits for HPHT. Further, in some instances, HP (high pressure) may be considered as beginning at about 5,000 psi.

If a subsurface formation has fluids of calorific value, and especially includes acid gases (H₂S, CO₂ etc.) at HPHT conditions, the wet supercritical phase(s) can have certain ionic species and possibly be electrically conductive. Thus it may be difficult to differentiate between a fresh water wet formation and a commercially productive reservoir having such fluids based on electrical resistivity. The foregoing phenomenon has been confirmed from field tests using a sample taking instrument sold under the trademark MDT (also a trademark of Schlumberger Technology Corporation), in wells producing 100% CO₂ at HPHT in southern Mississippi, U.S.A. Thus, it is desirable to enable an instrument to measure the conductivity of such supercritical phases both in a core sample of the formation (to understand effects in a porous medium) as well as to quantify the resistivity of the supercritical fluid itself.

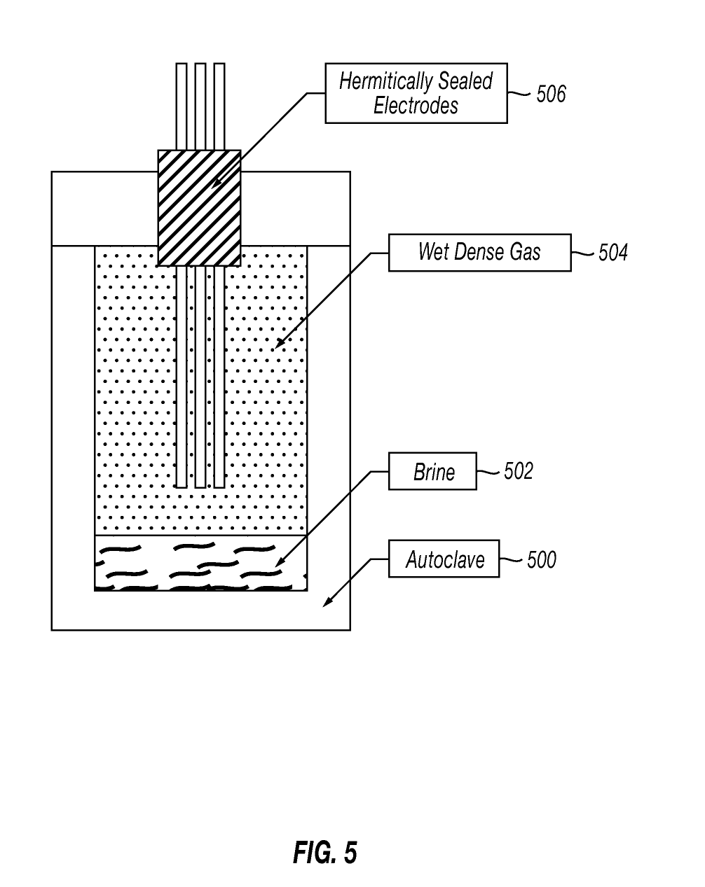

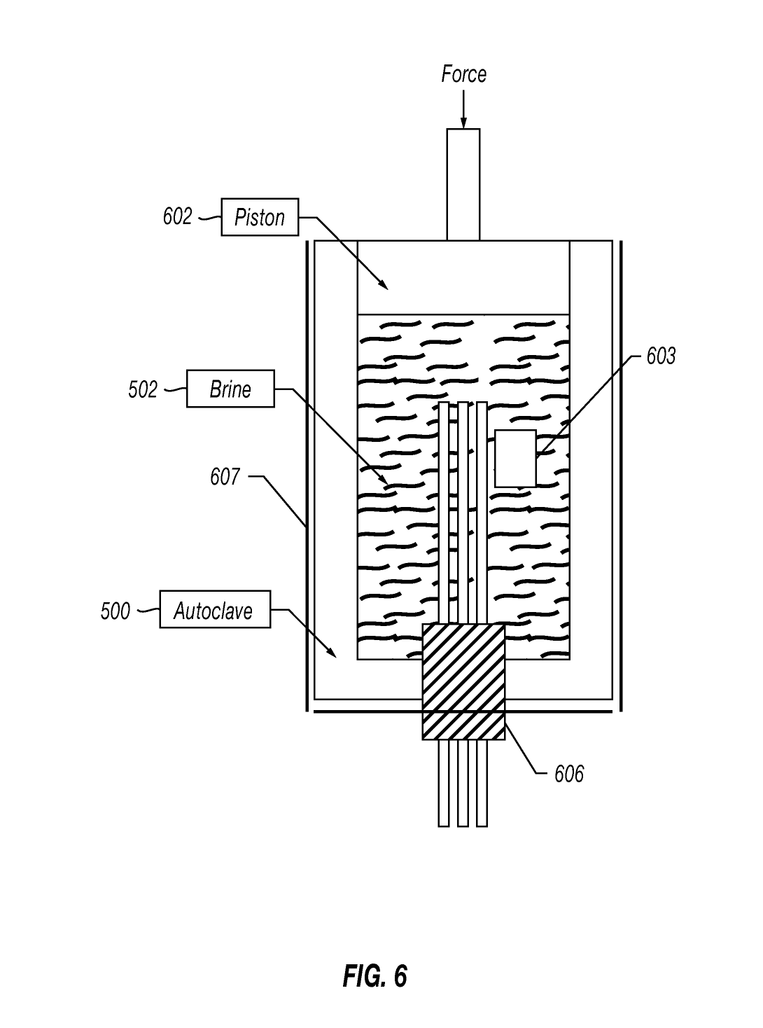

In one example, a fluid sampling instrument, such as the MDT instrument or substantially similar instrument that can withdraw samples of formation fluid, may include a fluid test chamber in hydraulic communication with internal fluid flow lines. The fluid sampling instrument in particular includes various sensors to assist the instrument operator in determining when the fluid passing through the internal flow lines is likely to be native reservoir fluid, rather than “mud filtrate” (the liquid phase of drilling fluid that enters permeable formations proximate the wellbore wall as a result of differential fluid pressure between the interior of the wellbore and the formation fluid). When the fluid flowing through the lines is determined to be native formation fluid, a sample thereof may be disposed into a pressure-sealed chamber, having at least one high pressure feed-through coupled electrode disposed therein. Examples of such chambers will be explained in more detail with reference to FIGS. 5 and 6.

The sample chamber (see FIGS. 5 and 6) may be a high pressure/high temperature (e.g., up to 36 ksi and 600 ° F.) H₂S/CO₂ resistant autoclave having electrical feed-through(s) designed for such operating conditions by engineered use of hermetically sealed single and/or multi-pin electrodes to electrically communicate with the fluids inside the sample chamber through the wall thereof. The electrodes may be of selected lengths dependent on the fluid level in the chamber and may be of a screwed-on type and made of a material selected based on the particular application (e.g., measurement of resistivity or determining corrosion of working electrode material). The electrode design can be single pins and/or concentric rings, or an isolated concentric ring designed to mitigate the effects of electrochemical polarization.

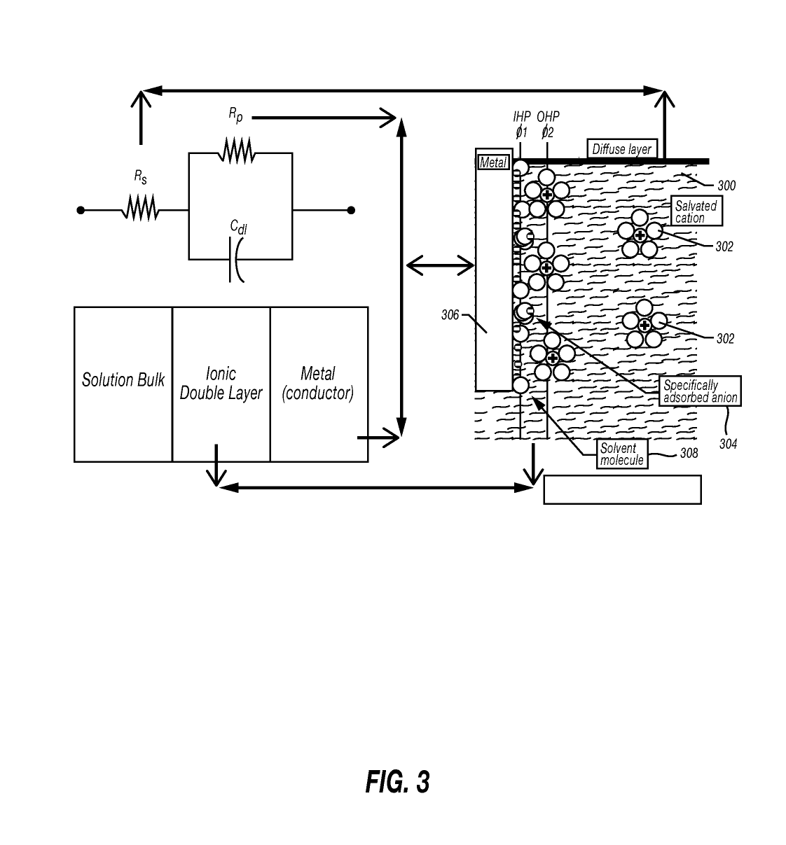

Referring to FIG. 3, an example of polarization resistance of an electrode, fluid resistance of a fluid disposed in the chamber, and an ionic layer will be explained to better understand how certain electrical properties may be measured using example chambers and electrodes according to the present disclosure. A metal electrode 306 may be disposed in a chamber containing a sample of formation fluid 300. A feed-through to obtain electrical connection to the electrode 306 from outside the chamber will be explained below with reference to FIGS. 5 and 6. The fluid 300 may have molecules 308 that can dissolve the metal in the electrode 306 and create ions. Solvated cations liberated from the electrode 306 are shown at 302. Adsorbed anions are shown at 304. The equivalent electrical circuit is shown on the left hand side of FIG. 3, and includes the fluid sample solution resistance (Rs), the polarization resistance of the electrode 306 (Rp), and capacitance (Cdl) formed by two layers of ions proximate the surface of the electrode 306.

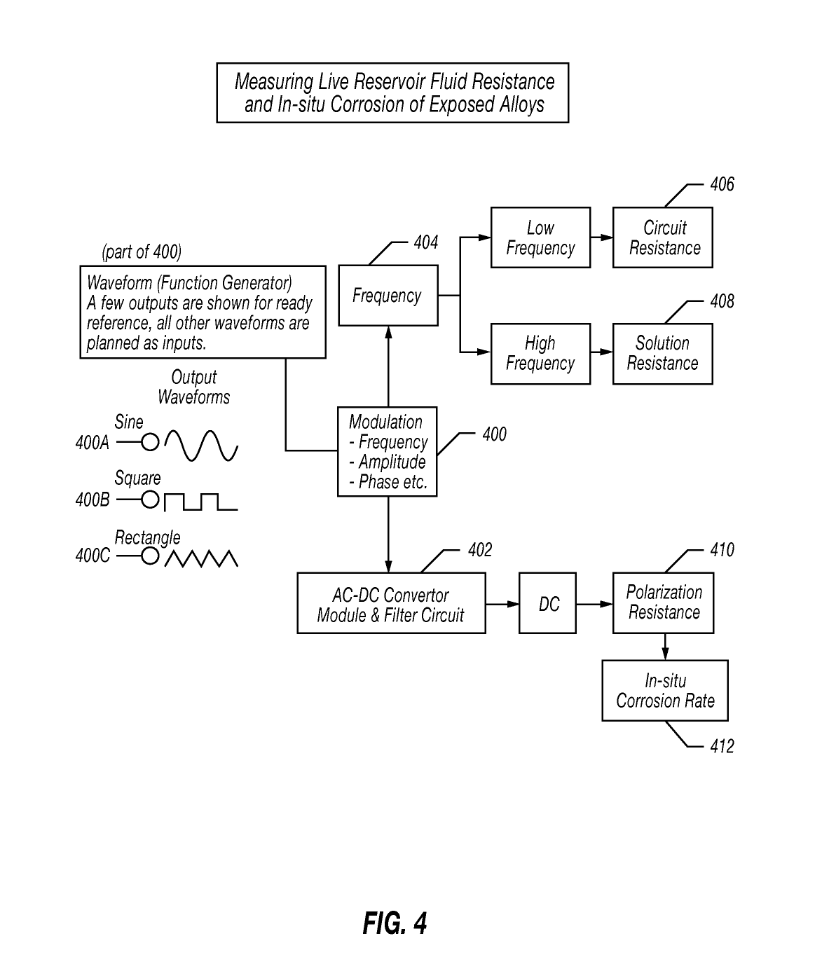

Referring to FIG. 4, an example impedance spectroscopy instrument will be explained. As illustrated, a power supply 400, which may include a waveform generator and a modulator, may be used to generate any selected waveform current to pass through electrodes. For example, the waveform generator may be implemented as a digital version of the desired waveform stored in a solid state memory or other suitable storage media, coupled to a digital to analog converter and low pass filter 402. The output of the filter may be coupled to a power amplifier. Example waveforms that may be produced by the power supply 400 are shown at 400A, 400B and 400C, but the foregoing examples are not intended to limit the scope of the present disclosure. Other implementations of the power supply 400 will occur to those skilled in the art.

In one example, an electric current may be passed between the electrode (306 in FIG. 3) and the chamber wall (FIGS. 5 and 6). The electric current may be a frequency swept current, for example in a range of 10 Hz to 2 MHz. At relatively low frequencies, the current magnitude may be affected by the electrode polarization resistance (Rp in FIG. 3), the reactive impedance of the capacitance (Cdl in FIG. 3) and the fluid resistance (Rs in FIG. 3) in series. This is shown at 406 in FIG. 4. At higher frequencies, depending on the value of Cdl, the double ion layer capacitance effectively becomes a short circuit to the flow of electric current. Thus, the effective circuit excludes Rp, because the impedance of Cdl is approximately zero. At such frequencies, the fluid resistance, Rs, may be determined directly from the magnitude of the current flow. This is shown at 408 in FIG. 4.

The power supply 400 may then be instructed, programmed or otherwise caused to generate direct current DC. The effective circuit will then be Rp+Rs. Having previously determined Rs using high frequency AC, one may then readily determine Rp. This is shown at 410 in FIG. 4. The polarization resistance will depend on the nature of the fluid in the chamber and the composition of the metal used for the electrode (306 in FIG. 3). Having determined the polarization resistance, it is then possible, at 412, to determine the rate at which the selected electrode material may corrode in the presence of the particular formation fluid at its existing subsurface temperature and pressure. As can be appreciated, the determination of the various parameters states above, such as Rp (at 410), corrosion rate (at 412), circuit resistance (at 406), and formation water resistance (at 408) may be made using any suitable processing logic (e.g., including circuitry), which may disposed down hole as part of the fluid sampling instrument, down hole on another tool but separate from the fluid sampling instrument, or by processing circuitry located on the surface (e.g., part of surface control system 23 in FIG. 1).

In some examples, a platinum working electrode (WE), HPHT reference electrode (RE) and a platinum counter electrode (CE) may be provided with a hermetically sealed feed-through capable of withstanding pressures up to 30,000 psi and temperatures up to 600° F. The actual design may accommodate multiple hermetically sealed feed-through(s) of different materials (different WE) to allow assessment of corrosion rates on exposure to the live reservoir fluids.

FIGS. 5 and 6 show examples of a sample chamber in accordance with the various examples described herein.

The sample chamber 500 may be substantially as described above with reference to FIGS. 3 and 4, and may capable of withstanding the above stated pressures and temperatures (e.g., HPHT conditions). A hermetically sealed feed-through (506 in FIG. 5, 606 in FIG. 6) may enable various electrodes as described above to be disposed inside the test chamber at subsurface formation pressure and temperature while enabling electrical connection outside of the test chamber. In FIG. 5, the electrodes 506 may be disposed in a sample of formation gas 504 or gas condensate withdrawn, for example, using an instrument such as explained with reference to FIGS. 1 and 2. Circuitry known in the art may be coupled to the electrodes 506 to enable measurement of resistance/resistivity of the gas or condensate sample. As explained in the background section herein, such gases or condensates were previously believed to be electrically non-conductive. However certain experiments have shown otherwise under certain conditions. One purpose of the sample chamber shown in FIG. 5 may be to measure the resistivity of the formation calorific fluid, which may be less than infinity (i.e., a conductivity greater than zero).

In FIG. 6, the sample chamber 500 (which may be the same or a different sample chamber) may have hermetically sealed electrodes 606 entering the sample chamber 500 from the bottom so that the electrodes 606 are more likely to be disposed in formation water (brine) 502 rather than gas or gas condensate 504 as shown in FIG. 5. If the sample chamber 600 is to be used at the surface rather than in a sample taking instrument, a piston 602 may be used to provide fluid pressure equal to the pressure of the formation fluid from which the fluid sample 502 was taken. In such examples, the sample chamber 500 may include an external heating element 607 to maintain the fluid sample 502 disposed inside at the temperature of the formation from which the sample was taken. It will be appreciated by those skilled in the art that the pressure and temperature of the chamber shown in FIG. 6 may be selectively controlled. In this way, pressure/volume/temperature (PVT) information concerning various phases of acid gas reservoir fluids within water of various salinities can be determined and catalogued for future interpretation technique development.

In some embodiments, one or more of the electrodes, e.g., in FIG. 6, may have a mixer 603 coupled thereto to prevent phase separation. The mixer 603 may be, for example a gravity centrifuge or charge plates. Further, in some examples, one or more of the electrodes may be conducted from outside the chamber through a high pressure, insulated feed-through connector. In some examples, the electrode may be made from a material having a very low coefficient of thermal expansion, and may be coated with gold, platinum or another noble metal in order to resist corrosion and reduce the possibility of leakage when ambient pressure on the feed-through changes.

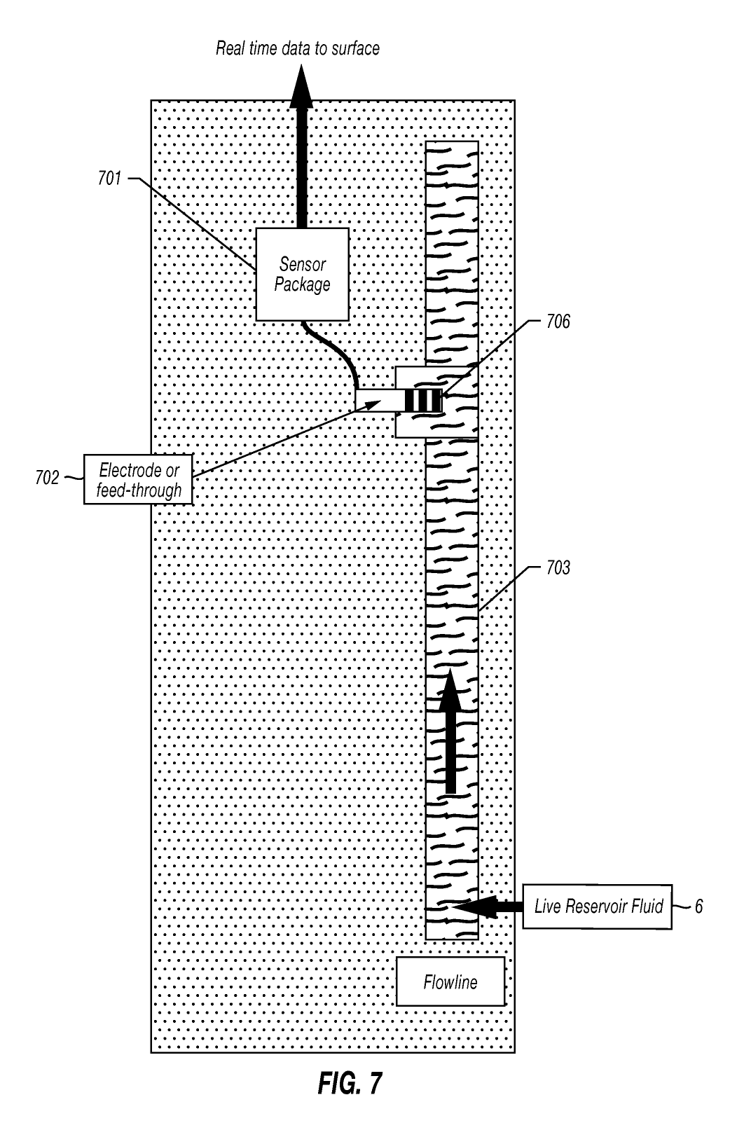

If the fluid sample taking instrument described above is used, there may be a mass spectrometer (not shown separately) or similar measurement instrument disposed within the sample taking instrument. A mass spectrometer may be used to determine the composition of salts dissolved in the formation water and/or the gas or gas condensate. Dissolved salt information may be used, for example, to assist in characterizing the likely rate of corrosion of metallic components used in completing construction of the wellbore. In such a determination, one or more of the electrodes disposed in the chamber may be made from a same metal as is intended to be used in completing the wellbore, e.g., for casing or a liner to be cemented in place, sand screen and/or gravel pack tubular, etc. Thus, a rate of corrosion of the selected metal(s) may be determine in situ using an fluid sampling instrument having a test chamber and circuits as explained with reference to FIGS. 3 and 4. An example test cell showing such arrangement for testing corrosion is shown in FIG. 7, wherein the probe 6 is used to withdraw fluids and cause them to travel in a flow line 703. The fluids move past a hermetically sealed (with feedthrough 702) electrode 706 coupled to a sensor system 701 as explained above.

Salt analysis may confirm or modify the corrosion prediction and enable the wellbore owner or operator to modify a well completion program as may appear necessary based on the analysis. The salts may be disposed in dense or supercritical vapors and may include inorganic ions in solution within a selected range of relative humidity. The salts may also be present in formation connate water having dissolved gases, inorganic compounds and/or trace organic compounds. The salt analysis may be performed using any suitable processing logic (e.g., including circuitry), which may disposed down hole as part of the fluid sampling instrument, down hole on another tool but separate from the fluid sampling instrument, or by processing circuitry located on the surface (e.g., part of surface control system 23 in FIG. 1).

A method and apparatus according to the various examples described herein may enable determining formation fluid resistivity and formation water resistivity at actual formation pressure and temperature conditions. Such determination may improve the quality of interpretation of quantities, saturations and mobilities of various fluids in a subsurface formation. Electrode potential resistance analysis and salt analysis may improve predictions of corrosion of wellbore completion materials and may enable the wellbore owner to make better choices about the types of materials used to complete a well. Electrode potential resistance analysis may also enable determination of at least one of susceptibility to environmentally assisted cracking in reservoir fluid or assessing hydrogen embrittlement by cathodically biasing electrodes used in such sampling apparatuses. In some examples, electrode resistance and fluid resistance measurement, combined with salt analysis may enable constructing a database of in-situ measurements to generate new scientific engineering and/or empirical models or to improve existing models of fluid behavior.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A formation fluid sample testing instrument, comprising:
a sealed chamber for receiving a sample of formation fluid, the sealed chamber maintainable at a selected temperature and pressure;
at least one electrode sealingly passing through a wall of the sealed chamber and extended into contact with the sample of fluid in the chamber; and
a power supply electrically connected to the at least one electrode, the power supply configured to generate direct current and alternating current having a selectable frequency.

2. The instrument of claim 1, wherein the alternating current has a frequency selectable to enable measuring resistance of fluid in the chamber; and
wherein the direct current is used to determine a full circuit resistance including the fluid and a polarization resistance of the at least one electrode.

3. The instrument of claim 1, wherein the sealed chamber is disposed in an instrument housing configured to traverse a wellbore drilled through subsurface formations, the instrument housing having at least one probe placeable in sealed communication with a selected subsurface formation and controllable flow lines and valves configured to selectably move fluid from the selected formation to an interior of the sealed chamber.

4. The instrument of claim 3, further comprising processing logic for determining at least one of the fluid resistance and the polarization resistance while the instrument is disposed in the wellbore.

5. The instrument of claim 3, wherein the instrument comprises processing logic for characterizing salts dissolved in or present in withdrawn fluid samples.

6. The instrument of claim 5, wherein the salts are dissolved in or present in at least one of dense or supercritical vapors, inorganic ions in solution with a selected range of relative humidity and formation connate water having at least one of dissolved gases, inorganic compounds and trace organic compounds.

7. The instrument of claim 1, wherein the sample chamber comprises means for controlling pressure and temperature of a fluid sample within the sealed chamber.

8. The instrument of claim 1, wherein the at least one electrode is constructed of at least one of platinum, gold, or another noble metal, and is positioned on an electrode substrate having thermal expansion coefficient less than a selected amount.

9. The instrument of claim 1, further comprising a mixer directly attached to the at least one electrode to at least one of separate phases, mix phases, or avoid phase separation.

10. The instrument of claim 9, wherein the mixer comprises at least one of one of a gravity centrifuge or charge plates.

11. The instrument of claim 1, wherein the electrode resistance is useable to estimate electrode material corrosion rate.

12. A method for analyzing fluid withdrawn from a subsurface formation, comprising:
disposing the withdrawn fluid in a chamber;
maintaining the fluid in the chamber substantially at a same temperature and pressure as exists in the subsurface formation; and
passing electric current through the fluid in the chamber using at least one electrode made from a selected metal, the electric current comprising direct current and alternating current of frequency sufficient to determine resistance of the fluid sample in the chamber directly, and from the direct current determine a polarization resistance of the at least one electrode;
wherein the fluid resistance provides reservoir information and the electrode resistance provides well integrity of downhole metals and alloys thereof.

13. The method of claim 12, wherein determining the electrode resistance is performed by an instrument disposed in a wellbore to determine at least one of susceptibility to environment assisted cracking in reservoir fluid or assessing hydrogen embrittlement by cathodically biasing the at least one electrode.

14. The method of claim 12, further comprising characterizing salts present in a fluid sample withdrawn from a selected formation under at least one of the following conditions:
the salts are disposed in dense or supercritical vapors;
the salts comprise inorganic ions in solution within a selected range of relative humidity; or
the salts are present in formation connate water having dissolved gases, inorganic compounds and/or trace organic compounds.

15. The method of claim 12, further comprising varying a pressure and a temperature of the fluid sample and determining at least fluid resistance and electrode polarization resistance at various pressures and temperatures.

16. The method of claim 12, constructing a database of in-situ measurements to generate an empirical model for fluid behavior.
